(19) United States
(12) Patent Application Publication
(10) Pub. No.: US 2017/0286867 A1
(43) Pub. Date: Oct. 5, 2017

(54) METHODS TO DETERMINE LIKELIHOOD OF SOCIAL MEDIA ACCOUNT DELETION

(71) Applicant: BATTELLE MEMORIAL INSTITUTE, Richland, WA (US)

(72) Inventors: Eric B. Bell, Richland, WA (US); Svitlana Volkova, Richland, WA (US)

(73) Assignee: BATTELLE MEMORIAL INSTITUTE, Richland, WA (US)

(21) Appl. No.: 15/467,879

(22) Filed: Mar. 23, 2017

Related U.S. Application Data
(60) Provisional application No. 62/318,276, filed on Apr. 5, 2016.

(51) Int. Cl. G06N 99/00; G06N 5/02; G06Q 50/00

(52) U.S. Cl. CPC G06N 99/005; G06Q 50/01; G06N 5/022

(57) ABSTRACT

A method for determining the likelihood of a modification of a social media account based upon the algorithmic review of preselected features including, but not limited to, a combination of profile, behavior, language, affect, and network features form the basis for highly accurate (0.82 accuracy) prediction of the deletion of an account.

### PRIORITY

This invention claims priority from a currently pending provisional patent application No. 62/318, 276 filed Apr. 5, 2016 the contents of which are herein incorporated by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

The invention generally relates to electronic social media accounts and more particularly to analytics for data verification in social media accounts.

### Background Information

In the field of social media, users from around the world have the ability to create accounts through which information may be shared, exchanged and commented upon. (As utilized herein a user may be an individual or a group, organization, corporation, government or other entity that has an interest in a social media account. It may also refer to a set of users or account owners.) The veracity and credibility of the information provided are important factors in determining the reliability of the information and hence its value in a variety of settings. Social networks are dynamically changing over time e.g., some account are being created and some are being deleted or become private. Understanding how and when these accounts are created, terminated or modified can provide important insights into how credible the information provided through these accounts is. For example, a deletion is typically something that results when accounts behave in off-normal manners, or out of concern for privacy. Understanding when an account is going to disappear is a key piece of information for a news agency using social media as a source for a story. Furthermore, understanding when an account may be deleted or suspended because of terms of service violations or deviation from community guidelines can enable a user to be aware as to when their account is likely to be suspended or deleted. What is needed is a methodology to be able ascertain when these activities are likely to occur based upon information that is generally and readily available so as to ascertain the veracity of information provided through the account. The method of the present disclosure provides a way to do this.

### SUMMARY

The present disclosure includes a method for determining the likelihood of a modification of a social media account based upon the algorithmic review of preselected features including, but not limited to, a combination of profile, behavior, language, affect, and network features form the basis for highly accurate (0.82 accuracy) prediction of the deletion of an account. The present disclosure also includes an embodiment wherein records are harvested from a social media user, each record having a social-media posting associated with one or more entities. At least one preselected feature from each record is then extracted and stored on a data storage device which includes a computer-readable representation of an attribute of one or more records. These records are then grouped into record groups according to users using clustering, classifying, and/or filtering algorithms executed by one or more processors. Records are also grouped into record groups according to features of each record using clustering, classifying, and/or filtering algorithms executed by one or more processors. A representation for each record group is then calculated and each representation is then input into a model. The model is then executed to calculate a probability class.

In some embodiments the calculated probability is labeled with a label correlated to a set of preselected labels. In some embodiments the model is optimized based upon the representation. In other embodiments the model is selected from the group consisting of logistic regression or log-linear model, random forest, and recurrent neural network. Depending upon the needs of the user, the computer-implemented method is a long-short term memory networks model. Records may be harvested from more than one source, and features may include profile, syntactic, stylistic, lexical, network and affect features. In addition, sources may include social objects, one or more foreign languages, or other items. In some applications the record may be analyzed on an individual basis without regard to the user. In other applications the method includes applying the optimized parameters from a trained model to unseen data to determine relatedness of the unseen data to the labeled data to predict or classify a specific type of behavior by a user. In some other applications the method may include retraining the model with new data. Some applications may also include deriving from statistical analysis on the representation of one or more attributes of one or more records or presenting a visual representation of that model on a display device.

Various advantages and novel features of the present disclosure are described herein and will become further readily apparent to those skilled in this art from the following detailed description. In the preceding and following descriptions I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### DETAILED DESCRIPTION OF THE INVENTION

The attached descriptions include the preferred best mode of one embodiment of the present invention. It will be clear from this description of the invention that the invention is not limited to these illustrated embodiments but that the invention also includes a variety of modifications and embodiments thereto. Therefore the present descriptions should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

Social networks have an ephemerality where accounts and messages are constantly being edited, deleted, or marked as private. These continuous changes come from a variety of instances including but not limited to concerns around privacy, a potential desire for to be forgotten and suspicious behavior. A methodology for predicting suspicious accounts (e.g., to be deleted or suspended accounts) in social media has been developed and tested on multiple datasets of thousands of active, deleted and suspended Twitter accounts. Utilizing this methodology a series of predictive representations were created that that would indicate an account as being suspicious and provide a flag for the removal or shutdown of such an account. A description of this methodology and its implementation in several data sets is described hereafter.

In one application data from the accounts from speakers of three languages—Russian, Spanish, and English, as well as their image and affect signals, language and network were analyzed to predict deleted and suspended accounts in social media. The predictive power of various machine learning models to recurrent neutral networks trained on previously unexplored features were compared. We found that unlike widely used profile and network features, the discourse of deleted or suspended versus active accounts forms the basis for highly accurate account deletion and suspension prediction. In particular, we observed that the presence of certain terms in tweets leads to a higher likelihood for that user's account deletion or suspension. This methodology can be expanded to improve the existing approaches to credibility analysis, disinformation and deception detection in social media. Furthermore, early detection of deleted and suspended accounts that can potentially be spreading misinformation and deceptive content can be important to ensure a safer and healthier environment in social media.

A technique to automatically predict “to be deleted accounts” (both suspended and intentionally deleted by users) on Twitter was created with the goal of excluding these accounts from sampled data to improve reproducibility of future studies. Unlike prior work on social bot prediction and suspended account analysis, this model performs deep linguistic analysis of user-generated content to contrast the predictive power of features across three languages, including those that have never been used for account deletion prediction such as: opinions, emotions, word embeddings, topics, and images, in addition to well-studied profile, network, and behavior signals. These models rely on a limited amount of user content, and, thus, are capable of making predictions in a constrained-resource scenario e.g., with only 20 tweets per user. By relying on topic and embedding features, these models make predictions from a low-dimensional feature space, and, therefore, are capable of processing high volumes of streaming data very fast with low memory requirements. Finally, these models do not rely on language-specific resources and perform well across languages, including morphologically rich languages like Russian and Spanish.

In one set of experiments data for English and Spanish tweet deletion seed materials was selected from an archive of the public 1% Twitter feed with no filtering criteria. The time period covered was Sep. 1, 2015 through Dec. 30, 2015. After issuing a query for tweets in the target language in January 2016, batches of 100 unique users were queried against the public Twitter API. Those returning active profiles were classified as non-deleted users. Missing profiles were classified as deleted users. Once approximately DS=100,000 unique non-active users were encountered per language, further queries were issued against the original dataset to retrieve all tweets in the repository by those users. The Twitter API was queried to further verify whether the account was deleted by a user or suspended. By selecting randomly from within the sample of non-deleted users, and retaining only individuals with at least five tweets in our dataset, we extracted another _D=100,000 unique non-deleted users. Examples of the types of content in deleted user tweets include—“ . . . best herbs for weight loss begin with green tea . . . ” and “ . . . lo mucho que quiero estar en to corazon tatuado . . . ” (how much I want to be in your heart tattooed . . . ) Examples shown have been selected to show generalities, but are not actual deleted tweets in adherence to Twitter policy and user privacy.

In another set of experiments we sampled Twitter accounts which mention Russia-Ukraine crisis-related keywords in Russian or Ukrainian. The example tweet content (translated) with crisis-relevant discourse—Cyborgs hung the Ukrainian flag in Donetsk Airport. The original dataset had 3.5 million users who used crisis relevant keywords during this period. We then re-crawled a random sample of one million accounts within a couple of months (June 2015) of the initial data collection (March 2015). We discovered that 30% of previously active accounts were not active anymore (have been deleted or suspended). We re-crawled these accounts in December 2015 to validate the accounts that have been deleted or suspended as of March 2015 and still remain non-active as of December 2015. We call this portion of the data deleted and suspended accounts DS=94,170. We then randomly sampled the same number of accounts that were still active e.g., not deleted as of March 2015 and still remain active as of December 2015. We call this portion of u ∈{D,S,D̅} or u ∈{DS,D̅} we were able to access at least 20 tweets as well as user profile metadata. In Table 1 we present statistics for English, Spanish, and Russian datasets in terms of the total number of tweets per language within deleted (D), suspended (S) and non-deleted (D̅) accounts, and the average numbers of tweets per user.

TABLE 1
The number of deleted D, suspended S and non-deleted D̅ accounts and
tweets per language.

| | | | |
|---|---|---|---|
| Type | Mean | Tweets | Accounts |

ENGLISH

| | | | |
|---|---|---|---|
| Deleted D | 18 | 1,479,747 | 82,435 |
| SuspendedS | 68 | 1,200,257 | 17,565 |
| Non-deleted D̅ | 35 | 3,503,232 | 100,000 |

SPANISH

| | | | |
|---|---|---|---|
| Deleted D | 9 | 855,751 | 91,161 |
| SuspendedS | 14 | 121,935 | 8,839 |
| Non-deleted D̅ | 130 | 12,999,202 | 100,000 |

RUSSIAN

| | | | |
|---|---|---|---|
| Deleted D | 20 | 275,275 | 13,845 |
| SuspendedS | 20 | 1,601,483 | 80,325 |
| Non-deleted D̅ | 20 | 1,872,723 | 94,170 |

We experimented with three types of models for account deletion prediction—deleted vs. suspended (2-way: D-S), deleted+suspended vs. non-deleted (2-way: DS-ND), and deleted vs. suspended vs. non-deleted (3-way: D-S-ND). We used scikit-learn toolkit (Pedregosa et al. 2011) to build models that can distinguish between deleted, suspended and non-deleted accounts. We tested several models including SVM and Random Forest. However, they yield lower performance compared to log-linear models and excluded them from our analysis.

Following standard practices for sentence classification, we implemented a Long Short-Term Memory neural network in Keras (https://keras.io/getting-started/sequential-model-guide/) for binary and multi-class classification using an embedding layer, a recurrent layer and an output layer. We utilized the sigmoid activation function (https://keras.io/activations/) and learn weights using RMSprop optimizer. (https://keras.io/optimizers/#rmsprop). We contrasted LSTM performance with the state-of-the-art log-linear models learned from features described below. Since Russian and Spanish are morphologically rich languages, we lemmatized words using the pymorphy package (https://pypi.python.org/pypi/pymorphy2) for Russian and snowball stemmer https://pypi.python.org/pypi/snowballstemmer) for Spanish to reduce sparsity and ensure better generalization.

We started by extracting ngram features from the pre-processed lemmatized tweets. We then excluded all stop-words and words with frequency less than five. We ran our experiments with log-linear models by varying word ngram size (unigrams, bigrams, and trigrams) for binary vs. normalized frequency-based ngram features. We performed linear dimensionality reduction on feature vectors extracted using normalized frequency-based bigram features as described above using Latent Semantic Analysis (LSA) implemented as truncated Singular Value Decomposition (SVD) in scikit-learn. http://scikit-learn.org/stable/modules/generated/sklearn.decomposition.TruncatedSVD.html

Similarly, we performed linear red to log-linear models and excluded them from our analysis.

Table 2 shows an outline of profile, syntactic, stylistic, lexical, network and affect features for account deletion prediction.

TABLE 2

PROFILE FEATURES |f^{Prof}| = 12
days since account creation,
number of followers,
number of friends,
number of favorites,
number of tweets,
friend-to-follow ratio,
name length in chars, bio in chars,
screen name length in chars,
screen name length in words,
bio length words,
avg. number of tweets per hour
SYNTACTIC AND STYLICTIC FEATURES |f^{syn}| = 14
aver. tweet length in words,
aver. tweet length in chars,
retweet rate: prop. of RTs to tweets,
uppercase word rate,
elongated word rate,
repeated mixed punctuation rate,
prop. of tweets with links,
tweets that are retweets (RTs),
prop. of tweets with mentions, hashtags, punctuation, emoticons,
mention, hashtag, url rate per word
LEXICAL FEATURES
Tweet ngrams (binary vs. count-based)
Tweet ngrams + LSA with c = [50, . . . , 1000]
Topics with t = [50, . . . , 1000] topics
Embeddings with d = [30, 50, 100 . . . 2000]
NETWORK FEATURES
Mentions (binary vs. count-based unigrams)
Mentions + LSA with c = [50, . . . , 1000]
Hashtags (binary vs. count-based unigrams)
Hashtags + LSA with c = [50, . . . , 1000]
AFFECT FEATURES |f^{affect}| = 10
Proportion of tweets with six Ekman's emotions
(joy, sad, fear, disgust, anger, surprise),
Proportion of tweets with positive,
negative and neutral sentiments
IMAGE FEATURES |f^{image}| = 2048
Image representation 2048-dim vector extracted using CNN

We then proceeded to learn topics using LDA https://pypi.python.org/pypi/lda on an independent sample of one million tweets for each language (Blei, Ng, and Jordan 2003). We varied the number of topics t=[50, 100, 250, 500, 1000], and tuned Dirichlet priors α and β. We found that the optimal values of priors are α=0.1 and β=0.005, and topics t=1000 by maximizing log-likelihood on a development subset of tweets. For English we relied on pre-trained embeddings obtained using GLoVe, http://nlp.stanford.edu/projects/glove/, Normalized Pointwise Mutual Information (NPMI) and Word2Vec https://radimrehurek.com/gensim/models/word2vec.html. For Russian and Spanish we learned word embeddings using Word2Vec model implemented in the gensim package with a layer size of 50. The embeddings are learned on the same corpus of one million tweets as LDA topics.

After learning embeddings, we assigned words to clusters by measuring cosine similarity between embedding pairs, and computed clusters using spectral clustering over a word-to-word similarity matrix. To extract sentiment features for Russian we predicted a polarity score for every tweet per user using the state-of-the-art sentiment classification system for Russian. Polarity scores vary around 0 (neutral) between −2 (negative) and +2 (positive). We then calculated mean polarity, and the proportions of positive, negative, and neutral tweets per account. To extract sentiment features for English and Spanish we predicted sentiment labels positive, negative, or neutral, for every tweet per user using pre-trained models from Volkova and Bachrach 2015, respectively. We then calculated proportions of positive, negative, and neutral tweets per user account. To extract emotion features across all languages, we predict one of six Ekman's emotions sadness, joy, fear, disgust, surprise, and anger for each tweet using an approach developed by Volkova and Bachrach 2015. Similar to sentiment features, we used six emotion proportions as features.

Beyond just being a classification system, Convolutional Neural Networks (CNNs) can be used as feature extractors, whereas the features produced by the top layers of the CNN can be used with great efficacy on tasks not related to the original task that the network was trained on, referred to as transfer learning. In this work we used the Inception v3 model trained on the ImageNet data set. The top softmax layer was removed from the network, leaving the final fully connected layer, which produced a 2048-dimensional vector for each image in our data set. Table 3 shows classification results for deleted vs. suspended (D-S), deleted+suspended vs. non-deleted (DS-ND), and deleted vs. suspended vs. non-deleted (D-S-ND) tasks obtained using 10-fold cross-validation (c.v.) with different feature combinations across three languages.

We balanced our deleted vs. non-deleted account datasets (DS-ND) to simplify the interpretation of classification results. For the experiments with imbalanced classes e.g., D-S-ND and D-S we report weighted F1 score. To find weighted F1 we calculate metrics for each label, and find their average, weighted by support (the # of true instances for each label). This alters macro F1 to account for label imbalance. We found that depending on language, different feature types lead to different performances. In terms of previously understudied content features syntactic and stylistic features and tweet ngrams yield the best performance for English and Russian, and embeddings features for Spanish. We outline our detailed findings below. Profile features yield higher performance in terms of F1 score for Russian but lower for English and Spanish (except for D-S classification). Syntax and style features show higher F1 for Russian (0.81) than for English (0.62) and Spanish (0.64) for DS-ND, and the best F1 for English (0.87) for D-S-ND and Spanish (0.90) for D-S classification.

Image features yielded the lowest performance for DS-ND and D-S-ND classification, and comparable F1 for D-S classification for English and Spanish. Table 3 also reports results obtained using LSTM models learned from tweet+network (hashtag and mention) features. We observed that neural network models consistently outperform log-linear models learned from different features for Russian. LSTMs yield the highest performance for deleted vs. suspended classification across languages, and comparable results for DS-ND and D-S-ND classification for English and Spanish. However, LSTMs take longer to train compared log-linear models—e.g., 30 minutes per fold per classification task with 20 epochs on a single GPU. In Table 3 account deletion prediction results obtained using 2000 embedding clusters that lead to the best performance are shown. By varying the number of clusters from 30 to 2000 and embedding type e.g., GLoVe. Sentiment and emotion features yield much higher performance for Russian (0.72) than English (0.53) and Spanish.

We found that all types of embeddings learned for English yield higher F1 scores compared to embeddings learned from Spanish and Russian (except for D-S classification). Embeddings learned using Word2Vec outperformed NPMI and GLoVe when the number of word clusters was less than 1000. We also observed that increasing the number of clusters leads to better performance. We found similar trends when we varied the number of topics. To show that differences between deleted+suspended (DS) and non-deleted (ND) accounts are statistically significant, we performed Mann-Whitney tests on account, affect, and syntactic features for DS-ND classification. We found all differences to be significant with a p-value of ≦0.001. We found that across all languages DS accounts use shorter names, have a lower follower-to-friend ratio, produce less tweets, and do not live long (e.g., have been active for less days). We observed that DS accounts produce shorter bio field descriptions across all languages except for Spanish and have significantly fewer favorites, followers, and friends. This may suggest that previous findings on following and friending strategies for spam accounts is different from deleted or suspended accounts. Alternatively, content polluters may change this behavior over time. For instance, fraudulent accounts labeled as “trolls” are created to look like real users. Trolls have similar follower and friend counts as the legitimate users, engage in conversations with other users, express opinions and emotions and share images.

We found that deleted and suspended accounts use fewer hashtags and mentions (except for English). In addition, we observed novel, previously unseen differences in shallow features across all languages DS accounts use less punctuation (except for Spanish), repeated punctuation e.g., ?????, !!!!, capitalized words e.g., WOW, and elongations e.g., noooo (except for English). In contrast to previous work, we observed that deleted and suspended accounts produce less retweets and URLs and more emoticons. On average DS accounts produce more opinionated content (less neutral)—positive and negative tweets (except for English). Previous work on applying sentiment features for influence bot detection 2016 observed similar behavior for English. However, our results demonstrate that these findings are not consistent across languages. We observed that DS accounts produce less anger↓ and fear↓ but more disgust↑ across all languages, and more sadness↑, surprise↑ and joy↑ (except for Spanish).

Early elimination of suspicious accounts on Twitter that can potentially be spreading disinformation, deceptive and abusive content will not only reduce sampling biases when building social media analytics e.g., flu detector or personality analyzer, but is also important to ensure safer environment in social media. We presented an approach and performed an extensive set of experiments for detecting “to be deleted or suspended” accounts on Twitter. We analyzed the predictive power of under-explored image and affect features, and text features such as topics and embeddings contrasting them with widely used network and profile signals. We have not only demonstrated that text features outperform profile and network features but also found that the presence of certain topics, hash-tags, and ngrams in user tweets leads to a higher likelihood for that users' account deletion or suspension.

We uncovered novel differences in deleted and suspended behavior of users speaking different languages. For example, we found that compared to active users deleted accounts: have shorted biographies in English and Russian, but not in Spanish; have less followers and friends in English and Spanish but not in Russian, use fewer hashtags and mentions, repeated punctuation, capitalizations and elongations in Russian and Spanish but not in English. Produce more opinionated content (less neutral)—more positive and negative tweets in Spanish and Russian but not in English; more sadness, surprise and joy in English and Russian but not in Spanish. Finally, we demonstrated that neural network models trained on text and network features yield the highest pre-diction performance for the majority of classification tasks across languages.

In another application the method of the present disclosure was utilized to analyze a series of data from deleted accounts in RuNet2 collected during the Russian-Ukrainian crisis in 2014-2015. In this application the aim was to focus on automatically identifying fraudulent accounts (sometimes called trolls). Trolls typically have similar followers and friend counts as the legitimate users engage in communications with other users, express opinions etc. That's why they are very difficult to detect compared to social bots or spam accounts. Bots, have no favorites and have no time zone, and never interact with other users through @replies and @mentions.

This original dataset had 3.5 million users who used crisis-relevant keywords during this period. We then re-crawled a random sample of one million accounts within a couple of months (June 2015) of the initial data collection (March 2015). We discovered that 30% of previously active accounts have been deleted. We re-crawled these accounts in December 2015 to validate the accounts that have been deleted as of March 2015 and still remain deleted as of December 2015. We call this portion of the data deleted ac-counts D=94, 170. We then randomly sampled tweets with crisis-relevant keywords as well as user profile metadata.

We used scikitlearn (Pedregosa et al., 2011) to build models for predicting deleted accounts in social media. We prefer log-linear models over other alternatives such as perceptron or SVM, however in some applications these models may also prove useful. Table 4 outlines a comprehensive list of features used to our build models. In addition to previously used account and behavior features our models rely on deeper linguistic analysis of content (tweets) generated by users, topics and embeddings, as well as visual and affect (sentiment and emotion) features. Since Russian and Ukrainian are morphologically rich languages, to reduce sparsity and ensure better model generalization, we lemmatized words using pymorphy2 package. https://pypi.python.org/pypi/pymorphy2.

We extracted bag-of-word (BoW) features from pre-processed lemmatized tweets; we also excluded all stopwords and words with frequency less than five; we ran our experiments varying word ngram size (unigrams, bigrams and trigrams) for binary vs. normalized frequency-based features. We performed linear dimensionality reduction on feature vectors extracted using BoW normalized frequency-based features as described above using Latent Semantic Analysis implemented as truncated Singular Value Decomposition (SVD) in scikit-learn. http://scikit-learn.org/stable/modules/generated/sklearn.decomposition.TruncatedSVD.html we also obtained independent confirmation by three native speakers of Russian and Ukrainian. The final lexicon contained 53 keywords in both languages e.g., Crimea, revolution, Donetsk, ceasefire, NATO, EU etc. we performed linear dimensionality reduction on feature vectors extracted using hashtags and mentions.

We varied the number of dimensions c=[50, 100, 500] to get the best F1 and report the results for c=100. We learned topics using Latent Dirichlet Allocation (LDA)10 (Blei et al., 2003) on one million tweets randomly sampled from the original 3.5 million tweets. We varied the number of topics t=[50, 100, 250, 500, 1000], and optimized α and β priors by minimizing log-likelihood. We reported the results for t=1000, α=0.1 and β=0.005.

We learned word embeddings for Russian using Word2Vec's skip-gram and CBOW models (Mikolov et al., 2013) implemented in gen-sim package11 with a layer size of 50. The embeddings are learned on the same corpus of one million tweets as LDA topics. After learning embeddings, we assigned words to clusters by measuring cosine similarity between two word embeddings, and computing clusters using spectral clustering over a word-word similarity matrix. Finally, to extract sentiment features we predicted a polarity score for every tweet for each user using the sentiment classification system for Russian developed by Chetviorkin et al. (2014), Loukachevitch and Chetviorkin (2014). Polarity scores varied around 0 (neutral) between −2 (negative) and +2 (positive).

We calculated mean polarity scores, and the proportions of positive, negative and neutral tweets for every user. To extract emotion features, we predicted one of six Ekman's emotions such as: sadness, joy, fear, disgust, surprise and anger for each tweet using an approach recently developed by Mohammad and Kiritchenko (2015) and Volkova and Bachrach (2015). Similar to sentiment features, we used six emotion proportions per user as features. Tables 4 and 5 show the type and examples of features considered in the analysis.

TABLE 4
Profile (account and behavior) features|f^{prof}|
days since account creation, number of followers,
number of friends, number of favorites, number of tweets, friend-to-follow
ratio, name length in chars, bio in chars, screen name length in chars,
screen name length in words, bio length words, avg. number of tweets
per hour
Visual features |f^{vis}| = 658
bag-of-words (BoW) on profile background color,
profile link color, text color, sidebar color,
background tile, sidebar border color, default profile image
Syntactic features |f^{syn}| = 14
aver. tweet length in words, aver. tweet length in chars,
retweet rate: prop. of RTs to tweets, uppercase word rate, elongated word
rate, repeated mixed punctuation rate, prop. of tweets with links, tweets
that are retweets (RTs), prop. of tweets with mentions, hashtags,
punctuation, emoticons, mention, hashtag, url rate per word
Network features |f^{men}| = 159, 563, |f^{ht}| = 7,983
mentioned and retweeted user (@mentions),
LSA on @mentions with c = [50, 100, 500] dimensions, BoW on
hashtags, LSA on hashtags with c = [50, 100, 500]
Lexical features |f^{lex}| = 110, 302
bag-of-words (BoW) on tweets, LSA on tweets,
LDA on tweets with t = [50, 100, 250, 500, 1000] topics
embeddings with d = [30, 50, . . . , 2000] dimensions
Affect (sentiment and emotion features) |f^{affect}| = 12
number of emoticons, prop. of emotions, mean scores,
prop. of tweets with positive, negative, neutral sentiment,

Account deletion classification results using individual feature types are discussed hereafter. We reported our results using 10-fold cross validation on a balanced set of 188,340 deleted and non-deleted accounts. We found that lexical features are the most predictive yielding F1 as high as 0.87. Interestingly, we found that frequency-based features outperform binary features. It means that for account deletion prediction it is not only important what the users say but how much they say it. We also found that higher order ngrams only slightly outperform unigram features. When the dimensionality of the feature space is reduced from 110K to 1000 (Embeddings), 1,000 (LDA), and 100 (LSA), classification results drop by 0.11, 0.06 and 0.03, respectively. Syntactic features extracted using shallow linguistic analysis demonstrate lower F1 than lexical features, but higher F1 of 0.81 than the rest of non-lexical features. With mentions demonstrating F1=0.78 and hashtags F1=0.76. Interestingly, unlike lexical features, binary and frequency-based mention and hashtag features demonstrate equal classification results. Our results revealed that for account deletion prediction it is not important how much the users use some hashtags or @mentions, but whether they use them or not Finally, sentiment and emotion features yield comparable F1 of 0.72 to visual features.

To show that the differences between deleted and non-deleted accounts are statistically significant we performed a Mann-Whitney U-test on account, affect and syntactic features. We found all differences to be significant (p-value ≦0.001). Deleted accounts typically have fewer followers than non-deleted accounts, but they have more friends. They also tend to have fewer favorites than non-deleted accounts, as well as the tweets, and significantly lower friend-to-follower ratio. Deleted accounts tended to have significantly shorter bios, but longer user names. Deleted accounts tended to generate shorter tweets, use fewer elongated words, capitalized words and repeated punctuation. They had lower hashtag, mention and url per word ratios. They produce significantly fewer retweets, tweets with hashtags, urls and mentions, tweets with punctuations and emoticons than non-deleted accounts.

Deleted accounts produced fewer positive tweets, but more negative and more neutral tweets compared to non-deleted accounts. Deleted accounts express less anger, but significantly more sadness and fear in their tweets. Both account types produce comparable amounts of joy, disgust and surprise emotions. Examples of the most discriminative n gram, mention, hashtag and topic features learned by our models are shown in Table 5, and the analysis thereof is shown in Table 6.

TABLE 5

| Feature | Example features sorted by predictive power for deleted D and non-deleted D accounts |
|---|---|
| Lexical | D: end, cressid, sokrin, alphabet, web money, haim, master, video segment, klyati, |
| | forest restoration |
| | D̅: arbi, mes, venta, lambesis, cozy, nikolay, restrict, agreement, perl, chubais, ethernet, |
| | insulation |
| Hashtags | D: #volkswagen, #win, #meat, #slovenia, #therewillneverbeanotheronedirection, |
| | #crishtian, #kebab |
| | D̅: #brent, #novorussia, #gromaidan, #leg, #hydroelectric, #media, |
| | #plantyourowntree, #underwater |
| Mentions | D: @newskazru, @volumesocial, @whafar, @max_7korolei, @chernyj1974, |
| | @dreamknoxville |
| | D̅: @agnfkvvaalena, blascepna72, @chico6, @xagiqasez, @kathrynbruscobk, |
| | @deanarianda |
| Topics | D: 337: beat up, resolve, press office, parliamentarian, intimidation; 376: |
| | accountability, position |
| | D̅: 792: reach, captain, fluffy, quit the job, shoot, satellite; 310: quarter, hitchcock, |
| | pitting, ensue |

TABLE 6
Classification results in terms of F1, precision (P), and recall (R) based on
individual feature types.

| | | | |
|---|---|---|---|
| Feature Type | F1 | P | R |

Profile

| | | | |
|---|---|---|---|
| Account + behavior | 0.85 | 0.84 | 0.86 |
| Visual | 0.73 | 0.65 | 0.083 |

Language

| | | | |
|---|---|---|---|
| Syntactic | 0.81 | 0.77 | 0.85 |
| BoW tweets | 0.87 | 0.89 | 0.86 |
| LSA tweets | 0.84 | 0.89 | 0.79 |
| LDA tweets | 0.81 | 0.85 | 0.78 |
| Embeddings | 0.76 | 0.68 | 0.85 |

Network

| | | | |
|---|---|---|---|
| Hashtags | 0.76 | 0.63 | 0.96 |
| LSA hashtags | 0.73 | 0.59 | 0.97 |
| Mentions | 0.78 | 0.66 | 0.96 |
| LSA Mentions | 0.72 | 0.60 | 0.91 |

Affect

| | | | |
|---|---|---|---|
| Sentiment + | 0.72 | 0.64 | 0.81 |
| emotion | | | |
| ALL | 0.82 | 0.79 | 0.88 |

The present methodology provides a way to predict various characteristics from a social media accounts including how credible the information provided through these accounts is based upon information that is generally and readily available. The method of the present invention provides a way to do use features us as lexical, topics, hashtags, mentions, sentiments and emotions, in addition to the existing profile arid behavior features to distinguish and ascertain activity with the account as well as the veracity of information. These features and the models created therefrom allow the building of highly accurate models for detecting suspicious accounts in social media.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A computer-implemented method of automatically identifying and verifying information about a social media account, the method comprising:
harvesting records from a social media user, each record comprising a social-media posting associated with one or more entities;
extracting at least one preselected feature from each record, each feature stored on a data storage device and comprising a computer-readable representation of an attribute of one or more records;
grouping records into record groups according to users using clustering, classifying, and/or filtering algorithms executed by one or more processors;
grouping records into record groups according to features of each record using clustering, classifying, and/or filtering algorithms executed by one or more processors;
calculating a representation for each record group;
inputting each representation into a model; and
executing the model to calculate a probability class.

2. The computer-implemented method of claim 1 further comprising the step of labeling the calculated probability with a label correlated to a set of preselected labels.

3. The computer-implemented method of claim 1 further comprising the step of optimizing the model based upon the representation.

4. The computer-implemented method of claim 1, wherein therein the model is selected from the group consisting of logistic regression or log-linear model, random forest, and recurrent neural network.

5. The computer-implemented method of claim 4 where in the model is a long-short term memory networks model.

6. The computer-implemented method of claim 1 wherein the records are harvested from more than one source.

7. The computer-implemented method of claim 1 wherein the feature is selected from the group consisting of: profile, syntactic, stylistic, lexical, network and affect features.

8. The computer-implemented method of claim 1, wherein the sources include social objects.

9. The computer-implemented method of claim 1, wherein the records comprise one or more foreign languages.

10. The computer-implemented method of claim 1 wherein the record is analyzed on an individual basis without regard to the user.

11. The computer-implemented method of claim 1 further comprising the step of: applying the optimized parameters from a trained model to unseen data to determine relatedness of the unseen data to the labeled data to predict or classify a specific type of behavior by a user.

12. The computer-implemented method of claim 1 further comprising the step of retraining the model with new data.

13. The computer-implemented method of claim 1, wherein the features are derived from statistical analysis on the representation of one or more attributes of one or more records.

14. The computer-implemented method of claim 1, further comprising presenting a visual representation of that model on a display device.

15. A predictive, language independent model for determining the ephemerality of a social media account comprising the step of utilizing a computer to analyze a series of features according to an algorithm to determine the ephemerality of a social media account.

16. The model of claim 15 wherein the features are selected from a group consisting of content-based features, network-based features, behavior, visual and profile features.
